(19) United States
(12) Patent Application Publication
(10) Pub. No.: US 2012/0212020 A1
(43) Pub. Date: Aug. 23, 2012

(54) Vehicle seat, in particular passenger seat in a passenger transportation vehicle

(76) Inventor: Benno Schiefer, Dusseldorf (DE)

(21) Appl. No.: 13/032,683

(22) Filed: Feb. 23, 2011

(51) Int. Cl. B60N 2/01; B60N 2/02; B60N 2/10; B60N 2/005

(52) U.S. Cl. 297/232; 297/452.1; 297/452.11; 297/344.1

(57) ABSTRACT

A vehicle seat, in particular a passenger seat in a passenger transportation vehicle, which is fastened releasably and adjustably on a supporting structure remote from the floor, is provided. A supporting tube is fastened in a horizontally projecting manner in a wall region of a vehicle. The vehicle seat is fixed to the supporting tube after being pushed onto the supporting tube.

### FIELD OF INVENTION

The invention relates to a vehicle seat, in particular a passenger seat in a passenger transportation vehicle, which is fastened releasably and adjustably on a supporting structure remote from the floor.

### SUMMARY OF INVENTION

Vehicle seats of the above-described type are designated in specialist circles as cantilever seats because the seat is fastened to a construction which is self-supporting to a limited degree. In passenger transportation vehicles, these types of seats are arranged on a fastening carrier which is arranged in a projecting manner on a wall or wall structure of the vehicle. Such arrangements have the advantage that a cleaning of the floor under the seat is very easily possible because there is no fastening to the floor. However, such seat arrangements require a secure fastening of the carrier structure on the vehicle wall, which, if appropriate, has to be reinforced in order to be able to reliably absorb the load moments which occur during the use of the seats.

In addition, the mounting and demounting of the vehicle seats should proceed easily so that, if appropriate, the seats can also be replaced rapidly or changed in terms of their seat orientation (in the direction of travel or counter to the direction of travel). In particular when two seats are to be fastened next to one another on a carrier, it is appropriate if the distance between the adjacent seats can be adjusted simply and easily. The known, so-called cantilever seats can only be oriented in the horizontal plane by means of elongate drilled holes.

An object of the present invention is to simplify a vehicle seat in production and handling such that it can be mounted and demounted easily and quickly, and such that, in addition to a lateral orientation, it can also be easily adjusted in an inclination.

According to the claimed invention a supporting tube, which is fastened in a horizontally projecting manner in the wall region of the vehicle and on which the vehicle seat can be fixed, is provided as the supporting structure for the vehicle seat. The supporting tube is stably fastened on one side to the wall structure of the vehicle and is designed in such a way that the vehicle seat can be pushed onto the supporting tube in the longitudinal direction thereof. As a result, a very rapid mounting and demounting of the vehicle seat is made possible. A rotation of the vehicle seat with respect to the seating direction of the passenger in the vehicle is likewise easily possible.

In order to fasten the vehicle seat on the supporting tube, a supporting profile which engages around the supporting tube is arranged on the vehicle seat and can be pushed over the supporting tube and fixed with respect to the supporting tube. The supporting profile arranged fixedly on the vehicle seat is provided with an anti-rotation safeguard, for example in the form of screwed clamping connections, which allows a clamping of the supporting profile on the supporting tube. This type of fastening makes possible, on the one hand, the secure fastening of the vehicle seat to the supporting tube and also, on the other hand, the adjustment in its inclination by rotating the supporting profile with respect to the supporting tube. In the case of two vehicle seats fastened on a supporting tube, the distance of the seats from one another and/or from the vehicle wall can also be varied by the clamping.

In a preferred embodiment of the claimed invention, it is provided that the supporting profile is formed directly on the vehicle seat. This embodiment allows a favorable production of the vehicle seat with the integrated supporting profile, which in this case is a constituent part of the seat.

In a further embodiment of the claimed invention, it is provided that the vehicle seat is formed from a one-part shell forming a seat and a backrest, on which shell the supporting profile is formed by forming a loop. The loop formed on the shell engages around the supporting tube over an angle of wrap between 180° and 360°, it being preferred for the loop to be formed in the region between the seat and backrest to the side facing away from the seat.

In another variant, the loop can also be formed below the seat region in the foot region of the shell. In this case too, the shell is formed in such a way that the loop fauns the supporting profile for the seat. If, according to another feature of the invention, the shell of the vehicle seat is formed in a substantially S-shaped manner as viewed in cross section, a type of freely-swinging seat occurs with the fastening in the foot region.

In one embodiment of the claimed invention, it is proposed to reinforce the supporting profile formed directly on the vehicle seat. The supporting profile or the loop formed on the vehicle seat can be stiffened by reinforcements or embeddings of reinforcing elements in such a way that a secure fastening of the seat is ensured, irrespective of which material is used for the seat shell.

A particularly advantageous solution results if a profile tube is fixedly arranged within the supporting profile as a reinforcement of the latter, the inner profile of which profile tube corresponds to the outer profile of the supporting tube. Thus, it is conceivable to adhesively bond or laminate a profile tube in the loop, which profile tube corresponds in its inside diameter approximately to the outside diameter of the supporting tube and can thus be pushed onto the latter. The cross-sectional shape of the profile is arbitrary.

The laterally displaceable vehicle seat which can be varied in its inclination can be fixed in its use position by means of clamping fastenings on the supporting tube; by releasing the clamping fastening, the entire seat can be pulled off the supporting tube for demounting and pushed on for mounting.

In a particularly advantageous embodiment of the claimed invention, it is provided that the profile tube and the supporting tube are designed as extruded profiles with a continuous groove grid. Sliding blocks in the loop of the seat shell then allow a stepwise adjustment of the seat inclination depending on the groove into which the seat shell has been pushed or with which groove it corresponds.

The seat shell itself is formed, for example, from a sheet-metal, glass-fiber-reinforced plastic or a multiplex shaped part which, if appropriate, is stabilized on the rear side of the seat by means of a support profile adapted to the seat contour. The materials which are shown in a non-limiting manner can be easily processed and, in a favorable manner, allow the formation of the loop which can be pushed over the supporting tube. Of the vehicle seats thus formed, it is possible for a plurality of, preferably two, adjacent seats to be pushed onto a supporting tube and varied in their lateral spacing and, if appropriate, in their inclinations.

A particular advantage of the solution lies in the favorable design of the vehicle seat itself, in particular when the supporting profile is directly formed on the vehicle seat. In addition to the advantageous mounting and demounting of the seats and the simple orientation of the seats with respect to distance from one another and inclination, a particular advantage results from the fact that the upholstery can also be produced very easily. Cut-to-size fabric, leather or plastic webs or tubes of foam, plastic or other non-flammable materials can be pushed over the seat shell and fixed there.

As a result, the upholstery becomes very much simpler; repairs to upholstery damage can be carried out quickly and without problems because not only can the vehicle seats be easily mounted and demounted but also the upholstery can be removed from the demounted vehicle seat and reapplied.

### BRIEF DESCRIPTION OF THE DRAWINGS

An exemplary embodiment of the invention is illustrated in the drawing and is described below. In the drawing:

FIG. 1 shows the arrangement of two adjacent vehicle seats on a supporting tube in the region of the transition between the seat and backrest, and

FIG. 2 shows the arrangement of the supporting tube in the foot region of two adjacent vehicle seats.

### DETAILED DESCRIPTION OF INVENTION

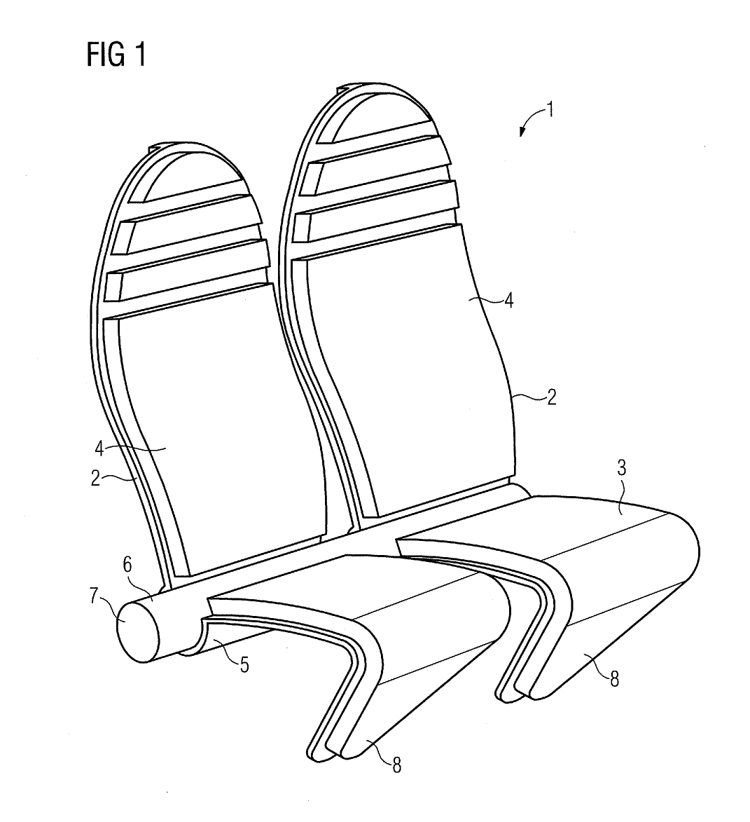

In FIG. 1, two adjacent vehicle seats of a passenger transportation vehicle are illustrated and designated overall by 1, each of the seats comprising a seat shell 2 formed in the example from glass-fiber-reinforced plastic. The seat shell 2 is substantially S-shaped in cross section between the foot 8 and back part 4, with the seat shell in the transition region between the seat 3 and backrest 4 forming a supporting profile 5 in the form of a loop 5. This loop 5 is pushed over a supporting tube 6 which is connected at one of its ends, at 7, to the wall structure of the passenger transportation vehicle (in a way which has not been represented), while the other end projects freely. The vehicle seats 1 have been pushed onto this supporting tube 6 in the longitudinal direction of the supporting tube 6. Here, the loop 5 of the seat shell 2 engages around a predominant part of the circumference of the supporting tube 6.

In the correct lateral position and in the correct seating position, the loop 5 is clamped with respect to the supporting tube 6 (for example by means of screws) and consequently the respective vehicle seat 1 is fixed in its position. According to the invention, the supporting tube 6 itself can be profiled or grooved in the longitudinal direction; for reinforcement purposes, a profile tube can be inserted within the loop 5 and fixed there by adhesive bonding or lamination. The profile tube corresponds in its internal circumference to the external circumference of the supporting tube 6 and allows the vehicle seat 1 or the supporting profile to be pushed onto the supporting tube 6 in order to fix it there by clamping.

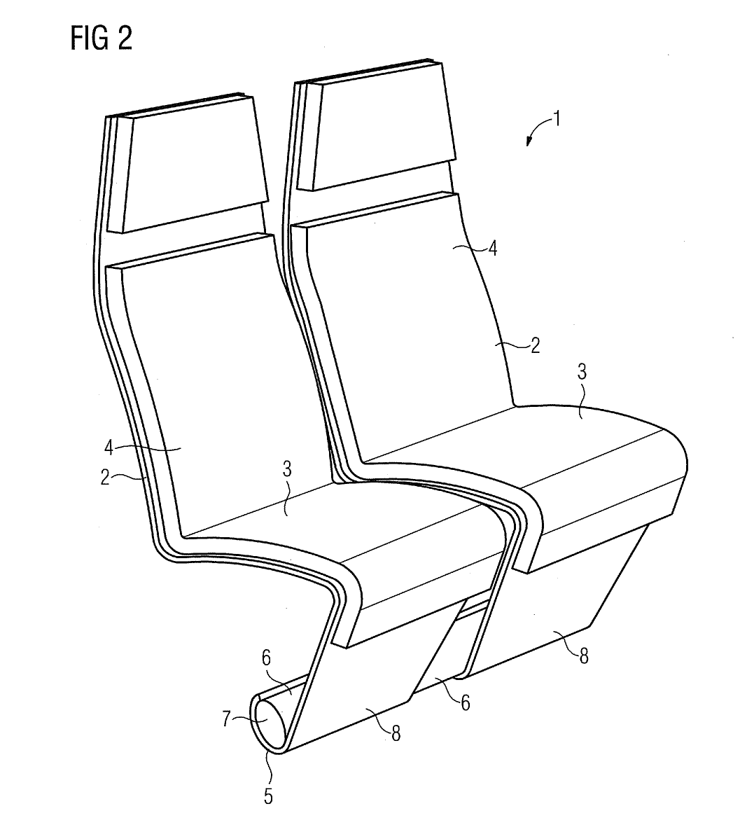

In FIG. 2, the loop 5 formed in the supporting shell is formed in the foot region 8 of the vehicle seat 1. Here too, the supporting tube 6 for the vehicle seat 1 is fastened in a freely projecting manner, at 7, to the wall structure of the passenger transportation vehicle; the vehicle seats 1 are pushed on in the same way as described for FIG. 1. After the fastening according to FIG. 2, a vehicle seat results in the manner of a freely-swinging seat as known in the case of chairs and armchairs. The vehicle seats 1 are only held in the foot region 8 via the supporting profile of the loop 5 and are as a result slightly resilient within their shell structure, depending on the material used. The supporting tube 6 is designed in such a way that a rotation of the vehicle seats 1 into and counter to the direction of travel is possible in that the vehicle seats 1 are simply pulled off the supporting tube 6, rotated and pushed on again. Here too, the vehicle seats 1 are fixed at least in the longitudinal direction of the supporting tube 6 by clamping. The vehicle seat inclination can likewise be fixed by clamping or else by configuring the interengaging profiles of supporting profile or loop 5 and supporting tube 6.

1. A vehicle seat, comprising:
a supporting structure remote from the floor, the vehicle seat being fastened releasably and adjustably on the supporting structure,
wherein the supporting structure is a supporting tube fastened in a horizontally projecting manner in a wall region of a vehicle, the vehicle seat being fixed to the supporting tube.

2. The vehicle seat as claimed in claim 1, wherein the vehicle seat is pushed onto the supporting tube in a longitudinal direction of the supporting tube.

3. The vehicle seat as claimed in claim 2, further comprising:
a supporting profile which engages around the supporting tube, wherein the supporting profile is pushed over the supporting tube and fixed with respect to the supporting tube.

4. The vehicle seat as claimed in claim 3, wherein the supporting profile is formed directly on the vehicle seat.

5. The vehicle seat as claimed in claim 1, wherein the vehicle seat is formed from a shell comprising a seat and a backrest, the supporting profile being formed onto the shell via a loop which engages around the supporting tube over an angle of wrap between 180° and 360°.

6. The vehicle seat as claimed in claim 5, wherein the loop is formed in a region between the seat and backrest to the side facing away from the seat.

7. The vehicle seat as claimed in claim 5, wherein the loop is formed below the seat region in a foot region of the shell.

8. The vehicle seat as claimed in claim 1, wherein the shell of the vehicle seat is formed in a substantially S-shaped manner as viewed in cross section.

9. The vehicle seat as claimed in claim 1, wherein the supporting profile formed directly on the vehicle seat is reinforced.

10. The vehicle seat as claimed in claim 1, wherein a profile tube is fixedly arranged within the supporting profile as reinforcement, an inner profile of the profile tube corresponding to an outer profile of the supporting tube.

11. The vehicle seat as claimed in claim 9, wherein the laterally displaceable vehicle seat, which can be varied in an inclination, is fixed by clamping fastenings on the supporting tube.

12. The vehicle seat as claimed in claim 9, wherein the profile tube and the supporting tube are designed as extruded profiles with a continuous groove grid.

13. The vehicle seat as claimed in claim 1, wherein the seat shell comprises a sheet-metal, GRP or multiplex shaped part which is stabilized by a support profile adapted to a seat contour.

14. The vehicle seat as claimed in claim 1, wherein a plurality of adjacent seats is pushed onto a supporting tube.
